(19) United States
(12) Patent Application Publication
(10) Pub. No.: US 2010/0253501 A1
(43) Pub. Date: Oct. 7, 2010

(54) SYNCHRONIZED LUMINATED SAFETY APPAREL

(76) Inventor: DELVONO GIBSON, Oakland, CA (US)

Correspondence Address: Thien Tran/ Access Patent Group, LLC, 7706 Tanner Robert Court, Springfield, VA, 22153, US

(21) Appl. No.: 12/753,070

(22) Filed: Apr. 1, 2010

Related U.S. Application Data
(60) Provisional application No. 61/165,509, filed on Apr. 1, 2009.

(51) Int. Cl. B60Q 1/44; B60Q 1/34; H05B 39/02

(52) U.S. Cl. 340/475; 340/479; 315/313

(57) ABSTRACT

A safety synchronized illuminated system includes wearing apparels worn on a person. A plurality of light strips is secured to the wearing apparels. The wearing apparels include jacket, helmet and a pair of gloves. A power source, CPU chip for timing, sequencer for time sequential selection and turn signal box activates the plurality of light strips in four items: jacket, helmet, a pair of boots and a pair of gloves in a one-by-one time sequential manner, and synchronized rolling fashion in light patterns and following the traffic color codes via wire or wireless link. Each of items of the apparel can be also activated individually, independently and separately. When the light strips are activated by switch and a power source, the wearing apparels worn on the person is more visible to others especially at night.

### CROSS-REFERENCE TO RELATED APPLICATION

This application claims the benefit of Provisional Patent Application No. 61/165,509, filed on Apr. 1, 2009, In the United States Patent & Trademark Office, the disclosure of which is incorporated herein by reference.

### BACKGROUND OF THE INVENTION

1. Field of the Invention

The present invention relates to signaling indicators, and more particularly, a synchronized illuminated safety system.

Automobiles have been outfitted with brake lights and turn signals for years. These are installed to help drivers become more visible to others on the road. Currently, there is nothing like this for individuals riding mobile vehicles, such as motorcycles, or those on foot. A large percentage of accidents occur because there is decreased visibility, especially at night. Joggers and bicyclists are often hit by automobiles because the driver was not aware they were turning or stopping. Although motorcyclists have lights, it can be difficult to see them. The reflective gear worn by crossing guards and policemen helps to make them more visible, however, it still does not allow others to predict future movements. A more effective way is desired. There may be a couple of reasons for this. If motorcycles are hard to see to begin with, then coming upon the rear end of a bike at a stop light, where the bike is probably at its narrowest profile (and the following automobile driver may be on a cell phone, drinking coffee, yelling at the kids, etc.) surely must be one of the most dangerous situations a rider can encounter. Also, since motorcycles have only one small brake/tail light, there just isn't much candlepower available to attract attention.

There are some studies that claim that human depth perception is affected when a smaller motorcycle is viewed among bigger cars and trucks, making the motorcycle seem farther away than it really is. Motorcycle brake lights are in a central location, rather than at a left and right end like a car's, and motorcycles don't have the automobile's center high-mounted stop light that places a brake light pretty much in direct line of sight to a following vehicle. And finally, with few exceptions, motorcycle brake lights are pretty wimpy. They have remained basically unchanged for the last 20 years or so.

2. Description of the Prior Arts

Numerous innovations for light signaling devices have been provided in the prior art that will be described. Even though these innovations may be suitable for the specific individual purposes to which they address, however, they differ from the present invention.

A FIRST EXAMPLE, U.S. Pat. No. 4,328,533, Issued on May 4, 1982, to Paredes teaches an illuminated safety harness adapted for wearing with or without a vest, and having a battery compartment in its belt connected through a switch to lamp sockets fixed on each shoulder. Each lamp socket is designed for a flashing light bulb. The harness has a plurality of reflective, luminescent or phosphorescent patches on its front and back to increase the visibility of the wearer during conditions of poor visibility. The elements of the electrical system are held in the harness which is fitted with snaps so it may be fastened to a vest, or to straps which fasten it directly about a user. The vest is preferably reversible with one side of a white reflective material for night use and the opposed side of a brightly colored material for daytime use.

A SECOND EXAMPLE, U.S. Pat. No. 4,559,516, issued on Dec. 17, 1985, to Schott et al. teaches a helmet with turn signal indicator for motorcycle riders and like applications which includes a pair of lamps respectively disposed on left-hand and right-hand sides of the helmet body, and head tilt switches responsive to momentary tilting of the wearer's head in a given direction for selectively energizing the lamp on the corresponding helmet side. The lamps are driven by flasher holding circuits which may be selectively extinguished by rearward tilting of the wearer's head. Fiber optics extend within the helmet from adjacent the lamps to above the wearer's eyes to indicate operation to the wearer.

A THIRD EXAMPLE, U.S. Pat. No. 4,559,586, Issued on Dec. 17, 1985, to Slarve teaches a rider's helmet for a motorcycle or the like having an auxiliary brake lamp secured thereto and connected via a quick detachable electrical connector in parallel with the brake lamp of the motorcycle.

A FOURTH EXAMPLE, U.S. Pat. No. 4,760,373, Issued on Jul. 26, 1988, to Reilly teaches a safety helmet to be worn by motorcyclists which contains a backward facing warning light which shines when the motorcycle's brake pedal is depressed. To avoid using a wired connection between the motorcycle and the helmet a transmitter is attached to the motorcycle and a receiver which activates the light is installed inside the helmet. A transmitter encoder and a receiver decoder prevent spurious sources of radio frequency from activating the receiver. A code card is used to guarantee that both the encoder settings and the decoder switch settings are identical.

A FIFTH EXAMPLE, U.S. Pat. No. 4,891,736, Issued on Jan. 2, 1990, to Gouda teaches a signal helmet with a lens whose surface is flush with the surrounding surface in close proximity to the lens. Three signal lights shine through and about the lens for giving tail, brake, and directional indications to following motorists at eye level of the following motorists. The helmet may be equipped with a cable coupled to the motorcycle upon which the wearer rides or the helmet may be telemetered to the motorcycle by a radio module in the helmet.

A SIXTH EXAMPLE, U.S. Pat. No. 5,040,099, Issued on Aug. 13, 1991, to Harris teaches a riders helmet for a motorcycle or the like having a rearward facing auxiliary brake lamp secured thereto spaced from and connected by an optic or sonic link to the brake light operating system of the motorcycle. The auxiliary lamp is caused to illuminate with the illumination of the brake lamp of the motorcycle.

A SEVENTH EXAMPLE, U.S. Pat. No. 5,353,008, Issued on Oct. 4, 1994, to Elkenberry et al. teaches a motorcycle helmet with a brake light that includes a duty cycled receiver circuit for receiving a radio frequency (RF) signal from a transmitter located on the motorcycle. The receiver circuit is generally turned off if the RF signal is not present. When the receiver detects the RF signal, the receiver is turned on. The brake light is illuminated when the receiver receives the RF signal. The brake light includes LEDs for providing light. The lens is a plastic lens which provides superior performance having spherical indentations on an interior surface.

AN EIGHTH EXAMPLE, U.S. Pat. No. 5,477,208, Issued on Dec. 19, 1995, to Henderson et al. teach an emergency flasher circuit for use with motor vehicles comprising an emergency switch, a signal generator for generating a signal having a frequency of approximately 10 Hz, and logic circuitry for selectively applying the signal to the headlight(s), and/or to one or both of the left and right turn indicator lights, for alerting other drivers to the presence of the motor vehicle. Alternatively, an optical shutter may be connected to the logic circuitry, and the headlight(s) or one or both of the left and right turn indicator lights for causing light generated by the headlight(s) and/or the turn indicator lights to flash at approximately 10 Hz upon activation of the horn switch, for alerting other drivers to the presence of the motor vehicle.

A NINTH EXAMPLE, U.S. Pat. No. 5,690,411, Issued on Nov. 25, 1997, to Jackman teaches a wearable vehicular signaling systems which enables pedestrians, runners, joggers, bicyclists, skaters, roadway and highway repair persons, visually impaired persons, children, elderly persons, school patrol persons, traffic police officers, and others to communicate or signal an intention to commence, continue, or resume forward motion; to turn or bear to the right; to turn or bear to the left; to cross the roadway or highway; or stop, in a manner that would be seen and understood by the operators of oncoming vehicles. Drivers would not only see the person using this device, they would also know what he or she intended to do. The device can comprise of direction signaling light subassemblies which are shaped, colored, and oriented to create a meaningful signal when controllably actuated. These direction lights can be supported by a vest-like garment. The shoulder straps and belts of this vest-like garment can by substantially adjustable in length so as to permit the device to be worn while the user's is also wearing a backpack or similar item. A battery or batteries residing removably in a battery compartment supported by the vest-like garment may be used as a means for powering the direction signaling lights. A panel of switches may be used to controllably actuate the direction signaling light subassemblies. The switch panel may reside removably on the vest-like garment and could be provided with means whereby it may be temporarily secured to the handlebars of a bicycle. Some or all the elements of this direction signaling could be provided, as kit for creating a customized wearable vehicular signaling system. Instead of a vest-like garment, the direction signaling light subassemblies could be arranged to create a wearable vehicular signaling system suitable for wearing about the arm or legs.

A TENTH EXAMPLE, U.S. Pat. No. 5,704,707, Issued on Jan. 6, 1998, to Gebelein et al. teaches a helmet-mounted wireless frequency-modulated infrared beam-actuated auxiliary brake light system capable of reliable operation in all ranges of ambient light while permitting the rider to turn his head from side to side over a large angle approaching 180 degrees or more. The system comprises a frequency-modulated infrared transmitter, in operative combination with a switch for detecting brake system actuation, and a helmet module, including a frequency-modulated infrared receiver and decoder in operative combination with a stop light. Brake system initiation results in switch actuation which causes the transmitter to emit a beam of frequency-modulated infrared energy towards the helmet module. When the beam is received at the helmet module, it is captured using a lens in operative combination with a novel light pipe which ensures reception over a 180 degree angle. The infrared energy is then transmitted through a solar filter which further discriminates between solar infrared energy and the infrared beam from the transmitter, before being received at an electro-optical circuit. This circuit decodes the frequency-modulated infrared energy and activates the auxiliary brake lamp.

AN ELEVENTH EXAMPLE, U.S. Pat. No. 5,856,779, Issued on Jan. 5, 1999, to Friday teaches a flashing motorcycle brake light enhancement system including a plurality of super bright light emitting diode (LED) modules which signal the driver of a following vehicle to slow down to avoid a rear-end collision. The application of the motorcycle's brake supplies input current to a plurality of (LED) modules via a flasher unit and connected wiring. The flashing circuit is controlled by a single, blinking light emitting diode, which is operated in combination with a resistor matched to a relay coil, to actuate a mechanical relay, which passes full battery voltage to the (LED) modules. In one embodiment the flashing (LED) modules are contained within weather-resistant housings which are attached in symmetrical arrangement and externally of the rear-mounted motorcycle brake light housing. In an alternative embodiment, the flashing (LED) modules and related components of the brake light enhancement system are mounted internally of the stock motorcycle brake light housing so as to be directed rearwardly and visibly to a driver in a following vehicle. The (LED) modules use very little electrical power and do not overload the pre-existing motorcycle brake light circuit. Further, this minimal use of electrical current causes no power variation and has no effect on the anti-lock braking system of motorcycle so equipped. The brake light enhancement system is provided in kit form so as to be adaptable to motorcycles of various manufacturers.

A TWELFTH EXAMPLE, U.S. Pat. No. 5,955,945, issued on Sep. 21, 1999, to Fuhrer teaches a system for use in monitoring the operation of motorcycle brake and tail lights is disclosed which, upon determination that a brake or tail light is not operating properly to provide a warning light signal, automatically provides an alternate warning light signal which is highly visible to traffic following the motorcycle. Current sensors are used to determine whether electricity is flowing through the brake light and tail light circuits, or, alternately, whether there is an open circuit condition in one or both circuits which is indicative of a burned-out bulb. If the tail light burns out, control switching elements are used to supply current to the left rear turn signal light, the right rear turn signal light, and the brake light to illuminate them, thereby providing a warning signal at the rear of the motorcycle. In addition, if the brake light burns out, control switching elements are used to supply current to the left rear turn signal light and the right rear turn signal light, thereby providing a warning signal at the rear of the motorcycle.

A THIRTEENTH EXAMPLE, U.S. Patent Office Publication No. 20020044052, published on Apr. 18, 2002, to Stewart teaches a motorcycle jacket which has turn signal lights attached to the back of the jacket in the upper left and right shoulder areas. The lights are electrically connected to the motorcycle electrical system, so that when the motorcycle turn signals are actuated, the jacket turn signals will flash in synchronism with them.

A FOURTEEN EXAMPLE, U.S. Patent Office Publication No. 20020145864, published on Oct. 10, 2002, to Spearing teaches a lighted signaling system connected to the electrical indicating system of a vehicle or devices on the vehicle which cause the vehicle to change direction or speed. The signaling system allows the user of the vehicle to clearly signal directional and vehicular intentions, including right turns, left turns, running and braking.

A FIFTEENTH EXAMPLE, U.S. Pat. No. 6,529,126, issued on Mar. 4, 2003, to Henry teaches a vehicle safety system used to enhance the safety of a motorist by emitting output signals from the helmet of the motorist using a unit attached to the associated vehicle that detects the operating conditions of the associated vehicle and transmits the conditions to a second unit, attached to the helmet of the operator to emit an output signal.

A SIXTEENTH EXAMPLE, U.S. Pat. No. 6,538,567, issued on Mar. 25, 2003, to Stewart teaches a motorcycle jacket which has turn signal lights attached to the back of the jacket in the upper left and right shoulder areas. The lights are electrically connected to the motorcycle electrical system, so that when the motorcycle turn signals are actuated, the jacket turn signals will flash in synchronism with them.

A SEVENTEENTH EXAMPLE, U.S. Pat. No. 6,558,016, issued on May 6, 2003, to Restauro teaches a motorcyclist garment with illuminated traffic signals for providing better and more visible rear lighting for motorcyclists. The motorcyclist garment with illuminated traffic signals includes a garment having a back side, a neck opening, and arm openings; and further includes a light-emitting assembly including light-emitting members being disposed in the back side of the garment, and also including wires and a power cord being connected to the light-emitting members, and further including a connector plug being attached to an end of the power cord and being adapted to plug into a power jack of a motorcycle.

AN EIGHTEENTH EXAMPLE, U.S. Patent Office Publication No. 20040177428, Published on Sep. 16, 2004, to Maese teaches a safety vest adapted to be worn by riders of exposed motor vehicles, such as motorcycles, which vest is designed to be worn over clothing and has luminescent signaling means interconnected with the signaling apparatus of the motor vehicle so that the rider's actions and intentions of braking, turning, changing lanes or hazard are visually communicated to other Motorists, thereby enhancing rider visibility and safety.

A NINETEENTH EXAMPLE, U.S. Pat. No. 6,834,395, Issued on Dec. 28, 2004, to Fuentes teaches a high visibility garment, and more specifically to a high visibility safety garment. The high visibility safety garment describes a simple circuit and power source that can power and sequence the LEDs or other switchable visible elements to light up or activate when appropriate and in a sequence if so is desired, such as to create a “moving image.” A single or multiplicity of arrows can light up in sequence when the corresponding turn signal is activated. The reference also teaches of a similar arrangement that is contemplated for the other arrow and stop pattern or any other appropriate patterns. The circuit can provide power and sequencing logic, including, but not limited to, on/off times, on/off sequences, visual effects, delays, and other appropriate effects. Fuentes' circuit is small and contained within the garment, alternatively, it can also be external to it and attached to the garment by a variety of possible means, including, but not limited to, a wire harness, a combination or wired and wireless links, among others. The power source can consist, but no be limited to, commercial batteries or similar devices. Furthermore, the driving circuitry may consist of, but is not be limited to, commercial display drivers, LED drivers, microprocessors, memory, encoders, decoders, and related and ancillary devices, to name a few. Method, apparatus, device and an article of clothing implementing the invention are also disclosed.

A TWENTIETH EXAMPLE, U.S. Pat. No. 6,997,573, Issued on Feb. 14, 2006, to Maese teaches a safety vest adapted to be worn by riders of exposed motor vehicles, such as motorcycles, which vest is designed to be worn over clothing and has luminescent signaling means interconnected with the signaling apparatus of the motor vehicle so that the rider's actions and intentions of braking, turning, changing lanes or hazard are visually communicated to other motorists, thereby enhancing rider visibility and safety.

A TWENTYFIRST EXAMPLE, U.S. Pat. No. 7,077,538, Issued on Jul. 18, 2006 to Wooldridge teaches an instrumented garment. The garment includes a vest portion, comprising a front portion and a rear portion. The garment further includes a first light emitting device disposed on the rear portion and a second light emitting device disposed on the rear portion. The first light emitting device is capable of receiving a first signal, provided by a vehicle comprising one or more wheels. The second light emitting device is capable of receiving a second signal provided by that vehicle.

A TWENTYSECOND EXAMPLE, U.S. Patent Office Publication No. 20090134992, Published on 05-28-2009, to Pacheco et al. teaches a traffic signaling device system for motorcyclists comprising a safety brake and running light assembly mounted to a motorcycle jacket. The safety brake light has an L.E.D. housing supported by an outboard support member and a leather piece. A plurality of snap buttons can be used to secure safety brake light to jacket. The safety brake light has a six-conductor coil cable assembly extending outside of jacket in front thereof is connected to a control box panel so that the rider can view the operation of control box panel in a convenient seated position. At one end of control box is a six-conductor cable which is electrically connected thereof to the existing wiring for a tail and brake light, a left turn signal light, and a right turn signal light in such vehicles. Other embodiments are described and shown.

A TWENTYTHIRD EXAMPLE, U.S. Patent Office Publication No. 20090257237, Published on Oct. 15, 2009, to Kincart teaches a safety system and apparatus which incorporates an illumination member into an article of apparel where the illumination member is capable of being activated so that it simultaneously corresponds to the illumination of a lighting system of a motor vehicle. A safety device kit includes an illumination member capable of being illuminated that can be contained within, or attached to, a wearable article that can be worn by a user and a separate activation device capable of activating an illumination member.

A TWENTYFOURTH EXAMPLE, U.S. Pat. No. 6,679,615 to Spearing describes the electrical indicating system of a vehicle controls the illumination of vehicular signals, including running lights, rear and front brake lights, and right and left turn indicators. Light sources on signaling modules are connected to the electrical indicating system of a vehicle such that the electrical indicating system also controls the illumination of the light sources. In a preferred embodiment, each vehicular indicator is electrically connected to a corresponding signaling pattern of light sources such that, for example, a right turn vehicular indicator illuminates a right turn signaling pattern of light sources. In another embodiment, devices on the vehicle which cause the vehicle to change direction or speed, including braking and steering devices, are electrically connected to corresponding signaling patterns of light sources such that, for example, actuating a braking device illuminates a braking signaling pattern of light sources.

In motor vehicle applications, it can sometimes be difficult for others to determine the signaling intentions of a user operating a vehicle. In particular, where the vehicle is a motorcycle, running, turning and braking indicators may be difficult to see because they are small and low to the ground. As traffic increases, it becomes even more imperative that other motorists are alerted to the presence and directional intentions of the cyclist so that they may avoid collisions and share the roadways safely.

Signaling devices for signaling presence and directional intention have been attached to vehicles in the prior art. Headlights, brake lights, running lights, and right and left turn signals have become standard and legally required vehicular indicators on motor vehicles.

Manual signaling means for signaling presence and directional intention have also been in use and are disclosed in the prior art. Equipment and apparel dedicated to enhancing visibility, including lights and colored or reflective clothing are typical. In addition, bicyclists have used their arms to signal their directional intentions, particular intentions to turn right or left. Further, the prior art discloses lighted devices which enhance the visibility of directional signals.

An advantage of a lighted signaling system is that it enhances the visibility of vehicular indicators like turn signals and brake lights. In particular, where the vehicle is a motorcycle (e.g. snow mobile, bicycle, scooter or other mobile vehicle), a lighted signaling system attached to an article of apparel such as a jacket and worn by a motorcyclist would be higher up than vehicular indicators attached to the frame of the motorcycle (e.g. snow mobile, bicycle, scooter or other mobile vehicle), and more visible to other motorists.

Connecting a lighted signaling system to either the electrical indicating system of the vehicle or devices on the vehicle which cause the lights to change direction or speed eliminates the need for a user to operate both the vehicle and the lighted signaling system. A user-controlled signaling system, such as those disclosed by the prior art, requires the user's attention to actuate and control signaling, which distracts the user from operating the vehicle and increases the risk of an accident. In contrast, the present invention is connected to and controlled by the electrical indicating system of a vehicle or devices on the vehicle which cause the lights to change direction or speed. The present invention is therefore safer and more reliable.

A further advantage of one embodiment of the invention wherein the wearable lighted signaling system is connected to the electrical indicating system of the vehicle is that the signaling does not require a separate power source but is powered by the electrical indicating system of the vehicle. As a consequence, the user is spared the inconvenience and expense of recharging or changing batteries to insure that the signaling system is operational at all times.

It is apparent now that numerous innovations for light signaling devices have been provided in the prior art that are adequate for various purposes. Furthermore, even though these innovations may be suitable for the specific individual purposes to which they address, accordingly, they would not be suitable for the purposes of the present invention as heretofore described.

### FIELD OF THE INVENTION

This invention provides a while it is contemplated that the vest and the vehicle's signaling apparatus will communicate by and through electrical wires that connect the vehicle to the vest, it is also preferable and contemplated that the signals conveyed through the vehicle's signaling apparatus (turn signals, hazards, reverse, brakes) may also be conveyed from either the vehicle's turn signal box or the independent signaling apparatus (turn signals, hazards, reverse, brakes) directly to the vest by way of commonly understood wire or wireless means, i.e., signals which are amplified, transmitted and received by the apparel's transceiver antennas described herein.

### SUMMARY OF THE INVENTION

AN OBJECT of the present invention is to provide an illuminated safety system that avoids the disadvantages of the prior art.

ANOTHER OBJECT of the present invention is to provide an synchronized illuminated safety system that is simple and inexpensive to manufacture.

STILL ANOTHER OBJECT of the present invention is to provide a synchronized illuminated safety system that is simple to use.

BRIEFLY STATED, STILL YET ANOTHER OBJECT of the present invention is to provide a synchronized illuminated safety system which comprises wearing apparel worn on a person (e.g. motorcyclist, rider, construction worker, policeman, officers, joggers, traffic coordinators . . . ). A synchronized lighting assembly is attachable to the wearing apparel. A power source activates the lighting assembly. When the synchronized lighting assembly is activated by the power source, the wearing apparel worn on the person is more visible to others especially at night.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

In order to more fully understand the manner in which the above recited and other advantages and objects of the invention are obtained, a more particular description of the invention briefly described above will be rendered by reference to specific embodiments thereof which are illustrated in the appended drawings.

The figures of the drawings are briefly described as follows:

FIG. 1 is a schematic view of how the apparel is outfitted with the helmet and colored to indicate different actions of the wearer;

FIG. 2A is a schematic front view of how the apparel displays the light strips for the sleeves and chest and the placement of the jack for the gloves, a sequencer and chip is shown;

FIG. 2B is a schematic front view of the rear of the apparel illustrating light strips as seen from a motorist behind wearer, also a collar jack is shown;

FIG. 2C is a schematic front view of the gloves with light strips attached.

FIG. 3 is a schematic rear view of the helmet showing light strips for the turn signals and receiver with antenna;

FIG. 4 is a schematic of the conventional motorcycle electrical signal system and illustrates the connections used for the light strips with the CPU chip and sequencer circuit built in to the apparel.

FIG. 5 is a schematic view of a pair of boots showing light strips for the turn signals and receiver with antenna;

FIG. 6 is a schematic view of how the lighting strips are synchronized on the apparels: jacket, helmet, a pair of boots, and a pair of gloves.

### REFERENCE NUMERALS UTILIZED IN THE DRAWINGS

Wearer 100
Helmet 200
Helmet light strips 201-218
Helmet antenna 250
Helmet sequencer 270
Helmet chip 260
Helmet receiver 308
Apparel 300
synchronized illuminated safety system 400
Extension wire 310
URJ universal relay jack 320
Right sleeve 330
Right sleeve strips 424-429 back
Right sleeve strips 404-409
Left sleeve 340
Left sleeve strips 433-438 back
Back light strips 421-438
Front chest light strips on the right 412-410
Front chest light strips on the left 401-403
Collar jack 307
Cuff jack 306
Turn signal box (from motorcycle) 350
Motorcycles' tail light box 360
CPU chip 370 of jacket 300
Flasher 371
Time sequencer 380 of jacket 300
a sequencer speed adjustment dial 372

### DETAILED DESCRIPTION OF THE PREFERRED EMBODIMENT

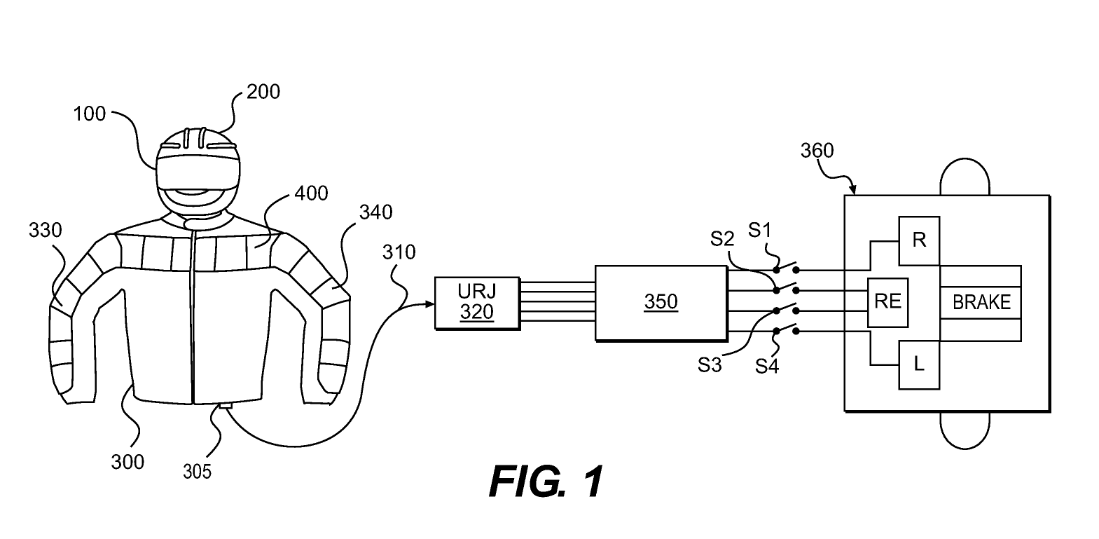

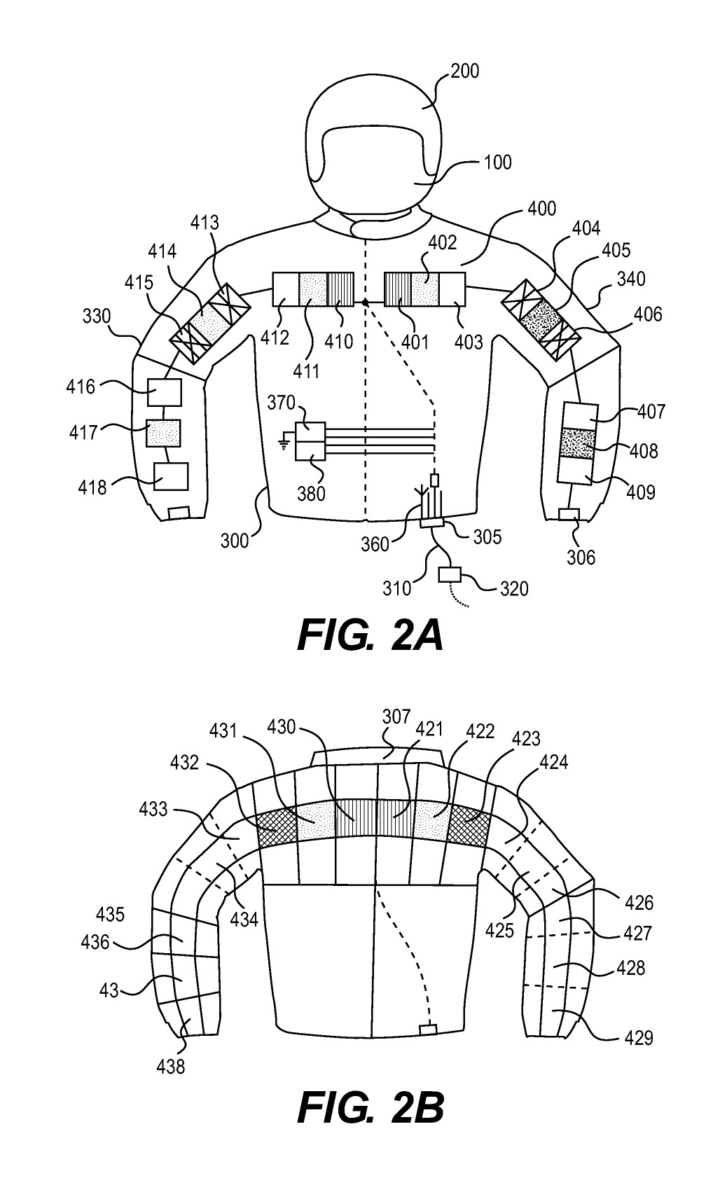

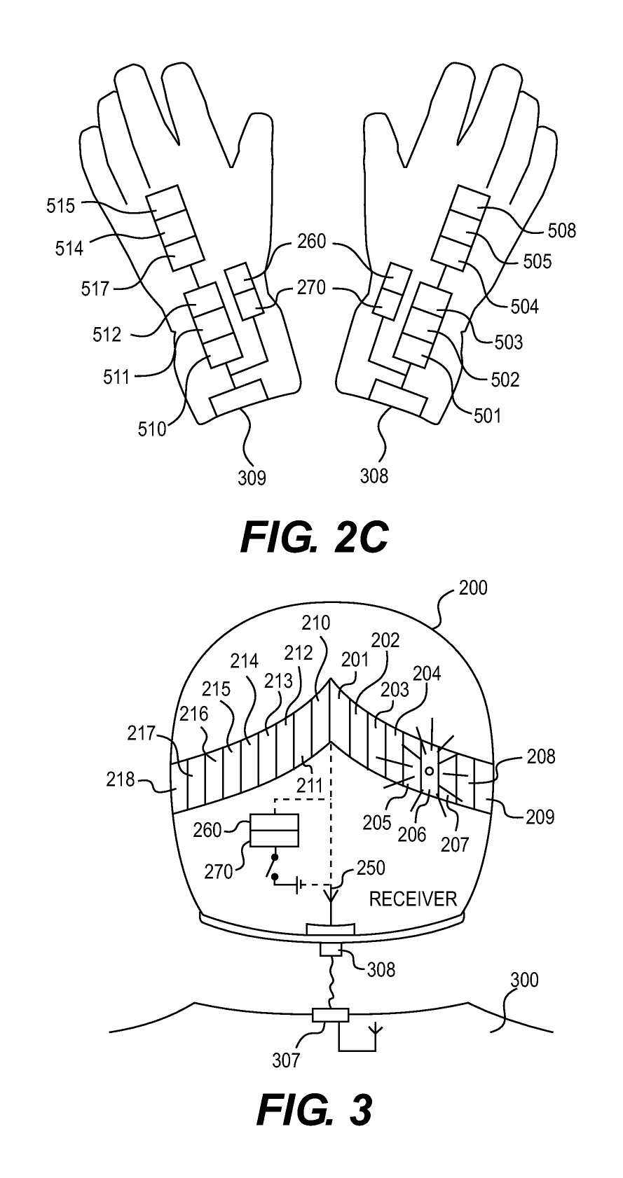

Referring to FIGS. 1, 2A-2B and 3, a synchronized lighted strip signaling system is provided for a wearer 100. The system includes a synchronized illuminated safety system 400. The wearing apparel comprises a jacket 300, a helmet 200 and a pair of gloves. The system 400 is attachable to the jacket 300. A power source activates the safety synchronized illuminated system 400. When the system 400 is activated by the power source, the jacket 300 worn on the person 100 is more visible to others especially at night. The system 400 comprises an article of apparel (e.g. vest or jacket 300), one or more signaling light strip(s) 401-418 are connected to the front of said jacket 300, a plurality of light strips 421-438 mounted on the rear of the jacket 300. Light strips' system 400 are arranged in one or more signaling pattern(s) block shaped or the smaller segmented stripes as shown in the FIGS. 2A-2B. Connectors 390 and 320 for connecting said helmet 200 and jacket 300 to the electrical system of the motorcycle is employed. More specifically, the unique feature of the design is that in another exemplary embodiment, apparel (e.g. jacket, vest . . . ) 300, helmet 200 and wear's gloves may be coupled to the lighting system of a motor vehicle and further incorporate wire or wireless technology which enables (URJ) to simultaneously or concurrently illuminate light strips's on the jacket, helmet, boots and gloves at the same time or same timing. Light strips may include on or more light emitting diodes (LEDs) or any other light sources such as, but not limited to, multiple strips lights, super LEDs, ultra LEDs, gas discharge lamps, neon lamps, mercury-vapor lamps, lasers, chemo luminescence, fluorescence, cathode luminescence, laser light, visible radiation, or any other means by which light may be produced. An extension wire 310 may be utilized to connect apparel 300 to universal relay jack (URJ). The extension wire 310 may include a magnetic coupling member so that connection of the wire to a motor vehicle (not shown) easily breaks free if a rider or user of article of apparel 300 forgets to uncouple extension wire 310 when dismounting the motor vehicle, motorcycle, snow mobile, bicycle, scooter or other mobile vehicle, etc. The connection operation is accomplished with no equipment and effort providing wearers extra safety and comfort knowing they are visible using the apparel, boots and helmet with gloves.

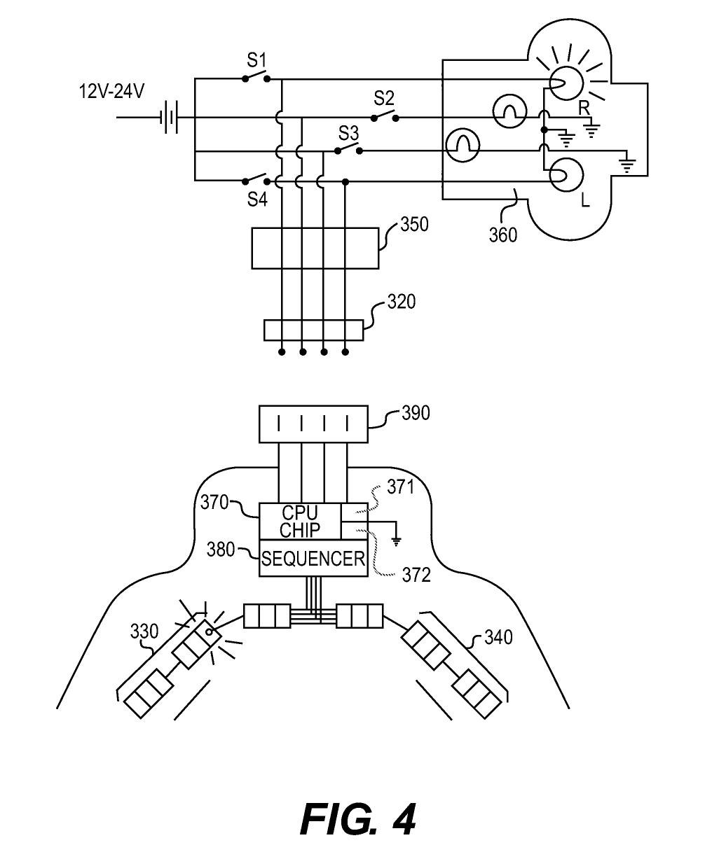

FIG. 4 shows a schematic of a conventional motorcycle electrical system comprising a three-conductor cable connecting a flasher 371 and a signal generator (including in box 350) to a battery (12 volts-24 volts) and to left and right turn signal switches S1 and S4. Three-conductor cable connects left and right turn signal switches S3 and S2 to left and right turn signal lamps. Three-conductor cables and are typical of the three-conductor electrical lines disclosed herein, all of which include hot wires and a ground wire. Three-conductor cables are shown for illustrative purposes only. A four-conductor cable or five-conductor cables are utilized if the tail light box 360 has a reverse light and brake light. Multiple-conductor cables should be used if there is more signal lights in the tail light box 360. Any equivalent electrical wiring which flexibly, reliably connects plug 390 to jack 320 can be substituted.

FIGS. 1 and 4 illustrate the light strips 320 and 340 are arranged in signaling patterns which may reflect vehicular indicators, including running, reverse, hazards, right turns, left turns and braking and of how the clothing may be outfitted differently to indicate different actions.

With regards to FIG. 2A, the apparel (e.g. jacket, vest, . . . ) 300 is provided with built-in light strips 400, and surround partially most of the right sleeve 330 and the left sleeve 340. Each sleeve has light strips 404-409 and 413-418 that illuminate when the wearer 100 activates the turn signals on the motorcycle, snow mobile, bicycle, scooter or other mobile vehicle. The sequence upon activation of the right turn signal 330, the topmost light strip 413 is energized and produces light therefrom and for a period of time by a CPU chip and a sequencer method describer later. Light strip 413 then turns off and the next light strip below 414 is energized and so on till light strip 418 is reached and the process begins again until the wearer 100 decides to quit indicating their intentions of making a right turn. As seen in FIG. 2C, gloves which have a plug and play feature to signal the chip 370 and time sequencer 380 to place the light strips in the circuit. Also to have the corresponding light strips 501-506 and 510-515 thereon which work in the same fashion as 330 but just adding the gloves to add more safety. The signal flasher 371 (inside the CPU chip 370) is known to make the lights blinking. Next, the CPU chip 370 can be a timing chip 555 for timing the blinking light or signal on and off in millisecond, and second intervals. The CPU chip can be a time programmable chip. Then, the time sequencer 380 can turn the light strips one-by-one. The time sequencer 380 can be a multistage light sequencer, or one-directional LED sequencer such CMOS ICs 74HC14, or 74HC138 or 74HCT138 or 74HCT138s or 4017 or similar being manufactured by Philips Semiconductors, NXP Semiconductors or Fairchild Semiconductor. The rate is being approximately 1/RC.

With regards to light strips 404-409 and 413-418 shown in FIG. 2A, it should be appreciated that all the light strips can flash on and off at once as a whole when each turn signal is activated. Additionally the sections 320 and 340 may blink or flash at a rate controlled by a sequencer speed adjustment dial 372 in combination with the CPU chip 370 which will be discussed later. Each sleeve can flash one-by-one in time sequence. Sections 330 and 340 will illuminate on and off exactly the same time to represent hazard signals. It is a further object of the invention to energize the light strips 423 and 432 at the same time and sequence to the next light strips 434 and 424 to display a double strobing as the light sequence continues down towards the wearer's 100 wrists which adds to the “hazards signal”.

As shown in FIG. 3, a helmet 200 has light strips 201-203 and 210-212 which are the red running and brake lights. A swooping shape of the light strip wraps from the rear to the front of the helmet 200 which indicates a turning motion is occurring as each light strip is energized in sequence. A collar jack 307 connects helmet 200 to the apparel 300 to communicate that the signals are to be indicated. Receiver jack 308 which may be embedded into the bottom of the back of the helmet 200 located near antenna 250 which is shown in phantom lines of FIG. 3. The circuits on a CPU chip 260 and time sequencer 270 and receiver jacks 308 and 305 are all part of the helmet 200 and apparel (e.g. vest, jacket . . . ) 300 which are connected with the universal relay jack box either wired or wirelessly (e.g. RF radio, microwave coupling, infrared coupling, Bluetooth, wifi, laser communication . . . ).

When the wearer 100 (driving the motorcycle) operates the brakes, the turn signals and shifts into reverse, portions of the light emitting diodes of the system 400 will be activated in response thereof making the wearer 100 and driving intentions of the wearer 100 more visible. In details, the light strips 201-202 and 210-212 are red color code or which resemble the STOP light or BRAKE signal on motorcycles. Light strips 203 and 212 are white and illuminate (optionally) only if a reverse action is required would light up and stay lighted till the wearer 100 cancels said reverse switch. Light strips 204-209 and 213-218 are orange/yellow color code or which resemble the color of conventional traffic turn signal lenses on motorcycles.

### Operation of the System:

In operation of the apparatus according to the present invention, the light strips are selected one of the bulbs or light emitting diodes (“L.E.Ds.”). In a preferred embodiment, the light strips comprise ultra-bright L.E.Ds. The light strips 330-340 may illuminate in a variety of colors that is blue may be used for police. In a preferred embodiment, red light strips are used to signal the vehicle is running, red light strips 421 and 430 are used to signal braking and yellow light strips 423 and 432 are used to signal right and left turns.

The light strips 400 are arranged in signaling patterns 401-409 and 410-418 which may reflect vehicular indicators, including running, right turns, left turns, braking and (optional) reverse. In a preferred embodiment as shown in FIG. 1, the signaling light strips 400 may be attached anywhere on the apparel 300, but preferably in positions where they will be readily visible to onlookers. In a preferred embodiment as shown in FIG. 1, light strips 401, 402, 403, 410, 411 and 412 are attached to the chest, light strips 404-409 and 413-418 for shoulders, elbows, wrist (form the near center of the wearer to the outermost) and 501-508, 510-515 on gloves so that people around the wearer can see wearer' signals clearly.

Signaling light strips on sleeves 330-340 may be designed in various shapes and sizes. Possible shapes include circles, ovals, squares, rectangles and irregular shapes. The signaling light strips can be any size, but should be large enough to be visible and support signaling patterns of light strips, and small enough to be worn or carried by a user/wearer. Signaling light strips' system or safety synchronized illuminated system 400 should be light weight and flexible so that the invention may be easily and comfortably worn or carried. Synchronized signaling light strips should be durable enough to withstand normal wear and tear on apparel. In a preferred embodiment, signaling CPU chips, time sequencer chip comprise thin, flexible, circuit boards.

With regards to FIG. 2B, the rear of apparel (e.g. vest, jacket . . . ) 300 is constructed in the exact mirror image of the front but light strip sections 430 and 421 are RED for the brake and running lights and light strips 422 and 431 are WHITE for the reverse lights. The upper left and right shoulder light strip sections colored orange/yellow color code for the turn signal section corresponding with light strips 424 and 433 of sleeves 330 and 340.

Installing and connecting the URJ is very straightforward. Fuses are provided to protect the circuitry within apparel 300 and helmet 200 (not shown), and thereby the wearer 100 thereof. There is one RED (power) and one black (ground) wire exiting the URJ controller box 320. Each wire must be connected to the corresponding ground and power wires of the motorcycle's brake light shown in FIG. 4. For most motorcycles, this is a simple matter of removing the motorcycle's RED plastic brake light housing and locating the ground wire and the hot wire to the brake light bulb. Splice in the URJ controller box RED wire to the motorcycle's hot (power) wire; then splice the black (ground) wires together. The controller 320 can be placed anywhere in the motorcycle's tail light box 360 or under the motorcycle's seat (not shown).

A way to splice wires is by using the posi-lock system; a system for connecting wires that avoids soldering, crimping, male/female electrical connectors or other, less reliable connecting schemes. The URJ controller box 320 is relatively unobtrusive; it measures about 1.75″ high by 1.75″ wide at the base (45 mm×45 mm). The URJ controller box 320 can be located just about anywhere on the tail light box 360 or under the seat of the motorcycle (not shown).

After locating the URJ controller box 320 under the tail of the motorbike, but before securing it, the next step is to locate the jack unit on the helmet 200. The optimal position for the location of the jack on the back of the helmet 200 is one that will give the best view of the inserting extension wire. Also, take into consideration the position of the URJ controller box unit 320 (on the tail of the motorbike) relative to the helmet unit's receiver; there should be a good, clear line of sight between the URJ and the receivers 308 and 305. In FIG. 3, the small antenna 250 (e.g. radio transceiver . . . ) is located on the bottom of the helmet 200.

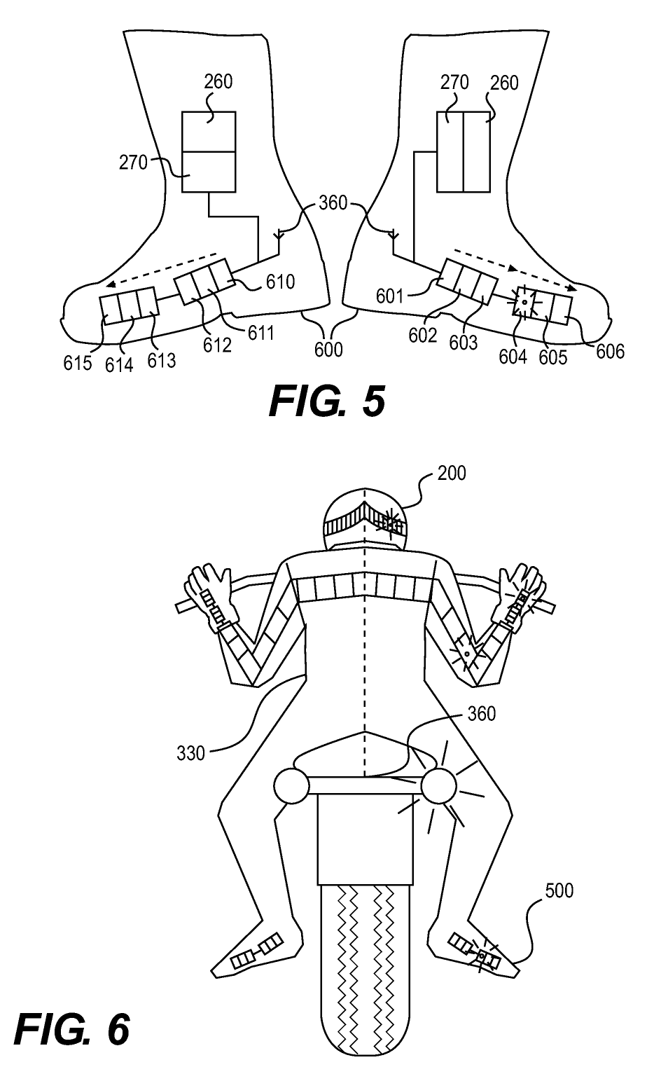

In FIG. 5, the lighting strips 601-606, 610-615 can also be embedded to the boots 600 or shoes in a similar fashion. The pair of boots has its own CPU chip 260 and sequencer 270, and antenna receiver on each boot.

In FIG. 6, the lighting strips are synchronized on the apparels: jacket 300, helmet 200, a pair of gloves and a pair of boots 600.

In sum, a CPU chip 370 and a time sequencer 380 are carried in the jacket 300 (and helmet 200) and are electrically connected to the safety synchronized illuminated system 400 in the jacket 300, the helmet 200 and the gloves, so as to turn signals going to the light emitting diodes on one by one or in sequential time (e.g. chasing pattern) and in a synchronized rolling fashion in light patterns of the four items: jacket 300, helmet 200, boots 600 and gloves. When the rider presses the brakes of their motorcycle, the rider's jacket, helmet, gloves would illuminate as red to indicate that the rider was braking.

The safety synchronized illuminated system 400 may be powered by pre-mounted jacks, a universal relay jack box that can be hooked up to any vehicle, or a portable backup power supply (1.5 Volts-24 volts). The system 400 is not limited to the features mentioned. It may apply to many different items and can be used for a wide variety of purposes. Each wearing apparel 300 may have different features. A step-down transformer is also used to step down the voltage (12 Volts, 13.5 Volts, 24 volts) from the motorcycle to the low voltage 1.5 volts or 3 volts being used on the apparel's light strips. The apparel can be vest, shoes, boots, gloves, pants, jackets, helmets, hats and etc. The exact specifications may vary. The communication can be universal hard-wired or a universal radio-transmitting device.

It is to be understood that the present invention is not limited to the embodiments described above, but encompasses any and all embodiments within the scope of the following claims.

It will be understood that each of the elements described above, or two or more together, may also find a useful application in other types of constructions differing from the types described above. While the invention has been illustrated and described as embodiments of a synchronized illuminated safety system, accordingly it is not limited to the details shown, since it will be understood that various omissions, modifications, substitutions and changes in the forms and details of the device illustrated and its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A safety synchronized illuminated system for a wearer which comprises:
a) a wearing apparel worn on the wearer;
b) a plurality of light strips secured to said wearing apparel; wherein a first strip on the front is identical to a second strips also on the front of the apparel; and
c) a power source, and a switch activates said plurality of light strips into blinking light in order to make the wearer be more visible to others especially at night;
d) a CPU chip with a flasher on the apparel, is utilized for timing the blinking light on and off in time intervals, and
e) a time sequencer on the apparel, can turn the blinking light in the light strips one-by-one in a time sequential manner and synchronized rolling fashion in light patterns starting from the near center of a wearing apparel to the outermost, wherein blinking light's rate is controlled by a sequencer speed adjustment dial.

2. The system as recited in claim 1, wherein said wearing apparel comprises a jacket, a helmet, pair of boots and a pair of gloves and wherein lighting signal can be simultaneously synchronized rolling fashion in light patterns in these four apparels: jacket, a helmet, pair of boots and a pair of gloves.

3. The system as recited in claim 2, wherein said light strips is selected from a group consisting of: light emitting diodes, multiple strips lights, super LEDs, ultra LEDs, gas discharge lamps, neon lamps, mercury-vapor lamps, lasers, chemo luminescence, fluorescence, cathode luminescence, laser light, and visible radiation.

4. The system as recited in claim 3, wherein said light emitting diodes are embedded into fabric strips that are applied to said jacket, said helmet, said boots and said pair of gloves.

5. The system as recited in claim 4, wherein said power source further comprises: a portable backup power supply carried within said jacket, boots, gloves and helmet.

6. The system as recited in claim 1, further comprising:
said plurality of light strips are electrically connected to the signal turn box of a motorcycle, so that when the rider driving the motorcycle operates the brakes, the turn signals and shifts into reverse, portions of said light strips will be activated in response thereof making the driving intentions of the rider more visible.

7. The system as recited in claim 6, wherein each portion of said light strips are traffic color code such as red for braking, white for reverse and orange/yellow for left and right turn signals.

8. The system as recited in claim 1, further comprising:
a wireless receiver carried in said jacket and for communicating wirelessly the turn signals from a signal turn box of motorcycle.

9. The system as recited in claim 8, further comprising: the wireless communicating is selected from a group consisting of: RF radio, microwave coupling, infrared coupling, Bluetooth, wifi, and laser communication.

10. The system as recited in claim 1, wherein the lighting signal can be individually, independently and separately activated in each of these four apparels: jacket, a helmet, a pair of boots and a pair of gloves.

11. The system as recited in claim 1, further comprising:
An extension wire and jack carried in said apparel and for communicating the turn signals from a signal turn box of motorcycle.

12. The system as recited in claim 1, further comprising a third strip on the back is identical to a fourth strip also on the back of the apparel in the case the apparel is a jacket.
